(19) United States
(12) Patent Application Publication
(10) Pub. No.: US 2014/0184908 A1
(43) Pub. Date: Jul. 3, 2014

(54) METHOD AND APPARATUS FOR MULTIMEDIA STREAM SYNCHRONIZATION

(71) Applicant: THOMSON LICENSING, Issy de Moulineaux (FR)

(72) Inventors: Ramkumar Perumanam, Indianapolis, IN (US); Jens Cahnbley, Princeton Junction, NJ (US); Ishan Mandrekar, Monmouth Junction, NJ (US)

(73) Assignee: THOMSON LICENSING, Issy de Moulineaux (FR)

(21) Appl. No.: 13/732,023

(22) Filed: Dec. 31, 2012

(51) Int. Cl. H04N 5/04

(52) U.S. Cl. CPC H04N 5/04
USPC 348/512

(57) ABSTRACT

The method and apparatus for multimedia stream synchronization includes establishing a hierarchical clock system for use in synchronization. The clock system includes establishing at least one parent clock and establishing a child clock for each multimedia stream to be synchronized. The parent clock is in communication with each child clock and through the implementation of rollover and prefetch state information contained with each established child clock, the parent clock can nominate any child clock as a master so as to enable multimedia stream synchronization.

### TECHNICAL FIELD

The present invention relates to multimedia synchronization. More particularly, it relates to the synchronization of video and audio multimedia streams.

### RELATED ART

Audio & video stream synchronization is typically accomplished by comparing the timestamps of an audio or video stream to a master clock and playing back the sample when the timestamps of the stream match the timing of the master clock. Typically, a master clock is considered to be a clock that is accessible for most streams that are to be synchronized together.

Sometimes when a stream is generated, the timestamps associated with the stream are in reference to a clock that is not available to the stream. It was then likely that this stream would be out of synchronization with the master clock if the timestamps associated with this stream do not correlate with the master clock. To solve this problem, the timing of the master clock would be adjusted to as to synchronize itself with the stream that lacked access to the unavailable reference clock. This solution however would not work well if two or more streams lacked access to their respective reference clocks because an adjustment to the master clock for one stream would not solve the timing problems associated with the second stream.

### SUMMARY

According to an implementation, an apparatus and method are described for providing synchronization for different multimedia streams and metadata. Each multimedia stream is associated with a child clock which can be implemented in software, hardware, or a combination thereof. Once the child clocks are spawned, one of the child clocks is designated as a master clock which becomes the controlling clock for the synchronization operation.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is block diagram of a synchronization system according to known prior art;

FIG. 2 is a block diagram of a synchronization system illustrating an embodiment of the presented principles;

FIG. 3 is a flow chart of a method for multimedia stream synchronization in accordance with the presented principles; and

FIG. 4 is a flow chart of a method for introducing clock state information for a child clock in accordance with the presented principles.

### DETAILED DESCRIPTION

The present principles are directed to synchronizing multimedia streams. The present description illustrates the present principles. It will thus be appreciated that those skilled in the art will be able to devise various arrangements that, although not explicitly described or shown herein, embody the present principles.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown. In addition, it is expected that the computer code used to implemented the described principles can exist in a non-transitory state form, as well.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), non-volatile storage, and the like.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

As mentioned above, stream synchronization becomes a challenging task as the number and type of streams to be synchronized grow and become more varied. According to an embodiment of the presented principles, multimedia synchronization is achieved through the implementation of a hierarchical clock based system.

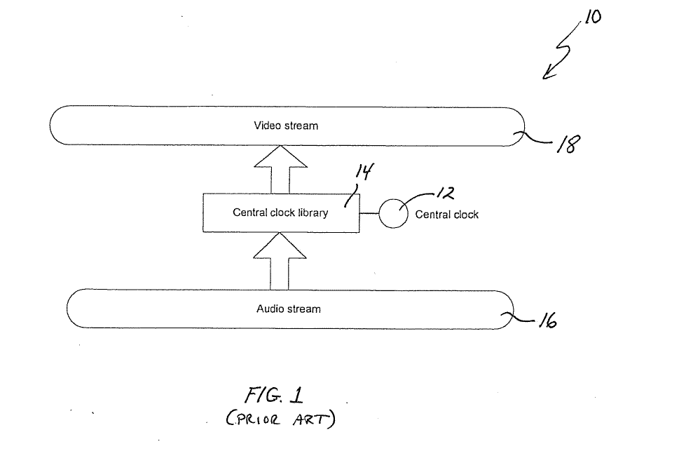

FIG. 1 shows a previously implemented synchronization scheme 10 which was referenced in the background discussion above. Specifically for synchronization scheme 10, central clock 12 is in communication with a central clock library 14, which is then in communication with the stream (16, 18). A stream such as audio stream 16 or video stream 180 can cause an adjustment to central clock 12 based on a clock associated with the stream. Different versions of such clocks adjustments schemes can be stored in the central clock library 14 where required clock adjustment scheme can be selected based on the type of stream that requires an adjustment to central clock 12. For example, a first type of audio stream could require a first type of adjustment for central clock 12 while a video stream could require a second type of adjustment for central clock 12, and the like.

Within the execution of synchronization scheme 10, other streams will only be able read the central clock to compare the timestamps within such streams to the central clock 12. That is, such other streams will not be able to affect the timing of the central clock 12 when an adjustment is made to the central clock 12 to accommodate a stream when such as stream lacks access to reference clock.

Other problems with system 10 include that is unlikely that the single central clock 12 can be used to have audio and video streams of unequal length rollover in a synchronized fashion. Also, system 10 is unlikely able to synchronize streams at a random point in a media processing chain.

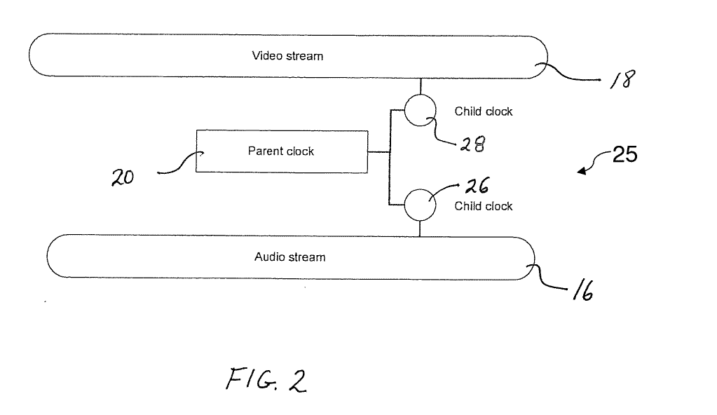

FIG. 2 presents hierarchical clock based system 25 to achieve multimedia stream synchronization in accordance with the disclosed illustrative principles. Each stream, audio 16 and video 18, creates an instance of a child clock 26 and 28, respectively. If there is a need to synchronize two or more streams with each other, an instance of the parent clock 20 is created and the child clocks 26 and 28 are associated with parent clock 20. One of the child clocks 26, 28 can be nominated as the master clock to drive the synchronization system 25. Because child clocks 26, 28 are all interconnected through the parent clock 20, the state information about child clocks 26, 28 is accessible and can be used to control start, stop, loopback or other conditions that require synchronous state changes.

Any type of child clock 26, 28, including a software clock can be nominated as the master clock. By using software based child clocks 26, 28 for each stream, synchronization system 25 becomes more flexible that the system shown in FIG. 1 and whereby the constraint of needing a hardware clock as a driver is not required because software based clocks are available. Thus, the availability to call up multiple instances of software based child clocks supports the synchronization of two or more video streams e.g. a primary stream at full resolution and a secondary Picture-in-Picture stream and/or a mosaic of video streams.

The principles described herein can also be used to synchronize audio and video with other types of metadata. For example, film grain metadata for an Advanced Video Coding (AVC) compressed video stream can be stored/transmitted using an out-of-band mechanism like log files. The addition of a film grain effect into a video frame typically occurs when a compressed video frame is decoded but before it is temporally re-aligned for display. When the grain information is read from a file, each grain sample needs to be correctly synchronized with the video frame to which it needs to be applied. Under the new scheme, a film grain synchronization operation can be accomplished by creating two child clocks 26, 28, one for the video stream and one for the film grain metadata stream, whereby both the metadata for the film grain operation and the video stream can then be associated with parent clock 20.

Referring back to system 25 in FIG. 2, two separate child clocks 26 and 28 can be maintained for the audio and video streams 16 and 18, respectively. The child clocks 26 and 28 are not only in communication with the parent clock 20, but are also in signal communication with each other. If multiple streams are present in the system 25, additional child clocks 26 and 28 can be created as needed.

In a related example, metadata related to offering a user a two screen experience can be used for controlling the output to a second screen device such as a tablet or computer where commands, video, audio, or a combination thereof can be outputted to a second screen device. The present principles would assign a child clock 26, 28 to the metadata that is for the second screen while another child clock 26, 28 is assigned to video stream 18 for output on a primary device such as a television. The metadata for the second screen can be controlled by the child clock 26, 28 so that is synchronized with both video stream 18 and parent clock 20. Moreover, a third child clock 26, 28 could be used to synchronize audio stream 20 with video stream 18 and the second screen metadata in accordance with the described principles.

In other implementations of the present principles, more than one parent clock 20 can exist simultaneously, thereby making it possible to have multiple independent synchronization systems in the same computer application and/or hardware. This is further illustrated by the previous examples where the synchronization of metadata and video for grain insertion happens independently and in addition to the audio and video synchronization performed at a rendering stage.

Due to the hierarchical nature of the present system, parent clock 20 can maintain a rollover state of the system as a whole. This allows parent clock 20 to control the child clocks 26, 28 to rollover in a synchronized fashion when needed. Most streaming players buffer or prefetch a stream to smooth out jitter in the inter arrival time of network packets. When content with unequal length audio and video tracks is streamed in a continuous loop, the two streams will rollover at different times at the video player. This skew can be mitigated by controlling the rollover and prefetch states of the system. To resolve this problem, as shown in FIG. 2, each stream 16, 18 creates an instance of a child clock 26, 28 that can maintain a prefetch and rollover state. Once a rollover is detected for a stream, the rollover state of the corresponding child clock for the stream can be communicated to the parent clock 20. That is, parent clock 20 checks the rollover state of all children clocks 26, 28 before computing a rollover state. In the case of unequal length streams, the parent clock 20 can send the first stream into prefetch stage while waiting for the second stream to roll over. Once the second stream rolls over, parent clock 20 can start the playback of both streams together, thus ensuring they are in tight synch with each other.

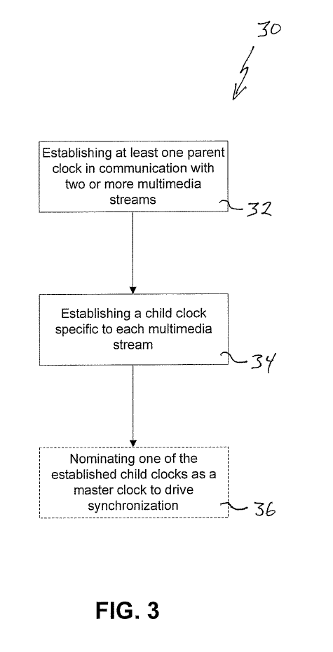

FIG. 3 presents a flow chart of a method 30 for multimedia stream synchronization in accordance with the presented principles. In step 32, a parent clock 20 is established which controls how two or more streams are to be synchronized when child clocks are introduced into the method. In step 34, each of the streams is assigned a corresponding child clock where two or more child clocks can be spawned as needed. In step 34, one of the child clocks is designed as a master clock which is used to control the synchronization of stream.

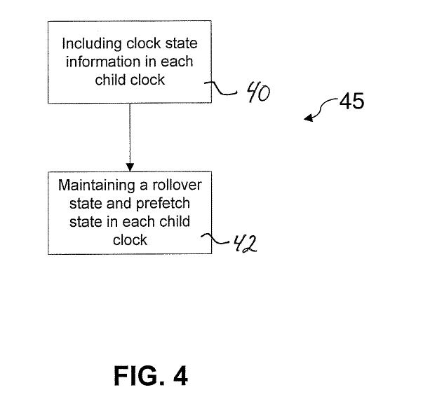

FIG. 4 presents a flow chart of a method 45 for indicating state information about child clocks in accordance with the described principles. In step 40, clock state information about each child clock can be communicated to other child clocks, parent clocks, and/or master clock. In step 42, the clock state information is used to enable a rollover state and/or a prefetch state as needed in accordance with the principles described above.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A method for multimedia stream synchronization, the method comprising the steps of:
establishing at least one parent clock in communication with two or more multimedia streams to be synchronized; and
establishing a child clock specific to each multimedia stream, wherein each child clock is in signal communication with all other child clocks and the established parent clock.

2. The method of claim 1, further comprising the step of nominating (36) one of the established child clocks as a master clock to drive the synchronization system.

3. The method of claim 1, wherein said step of establishing a child clock further comprises including in each child clock state information relating to that child clock.

4. The method of claim 3, further comprising controlling synchronization conditions using the state information of the child clocks.

5. The method of claim 1, further comprising maintaining a rollover state and prefetch state in each child clock, said parent clock utilizing the rollover and prefetch state of each child clock to synchronize streams of unequal length.

6. A system for multimedia stream synchronization comprising:
at least one parent clock; and
at least one child clock specific to each multimedia stream to be synchronized and in signal communication with the parent clock;
wherein said parent clock utilizes child clock information to effect synchronization of at least two multimedia streams.

7. The system of claim 6, wherein each of the at least one child clocks further comprise clock state information.

8. The system of claim 7, wherein each of the at least one child clocks further comprises rollover and prefetch state information relating to the child clock, said parent clock utilizing the rollover and prefetch state information to control the synchronization of the at least two multimedia streams.

9. The system of claim 7, wherein the at least two multimedia streams comprise an audio stream and a video stream.
